(19) United States
(12) Patent Application Publication
(10) Pub. No.: US 2002/0099648 A1
(43) Pub. Date: Jul. 25, 2002

(54) Method of reducing fraud in credit card and other E-business

(76) Inventors: Dana L. DeVoe, Columbia, SC (US); Timothy W. Jowers, West Columbia, SC (US)

Correspondence Address: F. RHETT BROCKINGTON, 4016 MACGREGOR DRIVE, COLUMBIA, SC, 29206, US

(21) Appl. No.: 09/759,723

(22) Filed: Jan. 25, 2001

Related U.S. Application Data
(60) Provisional application No. 60/233,733, filed on Sep. 19, 2000.

(51) Int. Cl. G06F 17/60

(52) U.S. Cl. 705/38; 705/39

(57) ABSTRACT

A credit card account having increased protection against fraud, wherein the credit card account has a usage line, which is a paradigm of rules for accessing the line of credit of the card account, where the usage line is set up and administered by the authorized user of the credit card account, and where the paradigm reflects the users buying preferences and level of concern for security. The authorized user can access the usage line over the internet, to periodically update buying plans, require explicit email approval for designated purchases, create rules for employee users, view a log of approved and declined transaction requests for purposes of analyzing for fraud, and remove all usage line constraints.

The invention relates generally to a method of credit card transactions; and more specifically to a method of transacting a credit card, wherein an authorized user limits the exposure to fraud.

The invention claims the priority filing date of Sep. 19, 2000, which is the filing date of the predecessor provisional patent application entitled “Method Of Reducing Fraud in Credit Card and Other E-business Transactions”, bearing serial No. 60/233733 and pending before the United States the Patent and trademark Office.

### BACKGROUND OF THE INVENTION

Credit cards have an expanded role in business, especially with the advent of e-commerce. Now, not only are cards accepted when presented in person at a store of a member merchant, but also in the total absence of a brick and mortar member merchant, the card or the person representing himself to be an authorized user. The vastly enhanced flexibility of use has come at a cost, increased credit card fraud. The threat of fine and imprisonment is not always a sufficient deterrent to prevent fraud, and there has been a disproportionate increase in abuse against sales volume. To deter abuse, a number of anti-fraud initiatives have been instituted by credit card processors (i.e. Visa, Discover, American Express, MasterCard), fiduciary institutions (i.e. banks, credit unions, large vendors, governmental entities), and organizations that serve the fiduciary institutions and processors (i.e. telephone companies, software companies, computer manufacturers, secure service encryption providers).

In general, the cost of implementation of anti-fraud initiatives has been borne by the member merchants, small businesses, and individual authorized users. The member merchants have had to install much more sophisticated encryption transaction devices to confirm a sufficiency of credit in the card account, and also update the member merchant of his own credit status. The encrypted communication prevents accidental disclosure of the details of the transaction to a potentially felonious, or otherwise interested, party. Authorized Users, whether individuals or businesses, have to provide more detailed personal and financial information, which can result in the very real perception in an unacceptable level of personal invasion of privacy, at a questionable level of overall reduced fraud. A representative example of an invention designed to cut down on fraud at the cost of personal intrusion is U.S. Pat. No. 6,095,413. Donald Tetro et al, of Automated Transaction Corporation, disclose a method, wherein it is asserted that transactions are made more secure by checking the card account number against the user's social security number. The account number and the social security number, which are already in the bank's database, are kept in yet one more database, so that the two can be compared. Kevin Rowney et al, of VeriPhone, discloses in U.S. Pat. No. 5,987,140 an invention illustrative of a system having enhanced security using encrypted communication through “a plurality of computer systems” between the merchant, the customer and the requisite number of middlemen. The underlying theme of these anti-fraud initiatives is that the problem can be controlled with increasingly more robust security measures, where security measures are militaristic in their origin. A necessary corollary to enhanced security is increased knowledge of the user. By contrast, a working caveat for the smooth flow of business is to keep it simple and cost effective. An extension of the historical approach tends to hurt business. A resource for reducing fraud that has been generally overlooked is the potential contribution of the credit card account holder. An exception to that is Robert Checchio's U.S. Pat. No. 6,052,675, assigned to AT&T, Corporation. Checchio describes a method wherein, prior to a purchase, the card holder notifies a member association having a database processor, that he is going to make a purchase at X time for Y dollars from Z merchant. Then, when he actually makes the purchase, he just presents his card to the merchant, who contacts the member association for confirmation. While no doubt the foregoing method ought to reduce fraud, it is cumbersome for general utility. Additionally, if for some reason the item had to be returned or was on backorder, then the transaction becomes much more complex. From the merchant's perspective it would probably also require joining an additional member association. Impulse buying is eliminated. What is desired is a method that would have the benefits of the Cheechio invention, without the constraints. A method wherein the authorized user is empowered, and as such, actively participates in the administration of his credit card account, where the account has a usage line where the authorized user can create a paradigm that defines the criteria under which the credit line can be accessed. It would be desirable that the paradigm not simply be an isolated transaction pre-authorization, but rather a reflection of the users concerns, tastes and lifestyle.

### SUMMARY OF THE INVENTION

The invention is a method of conducting credit card and other types of e-business transactions, wherein practicing said method results in a much lower incidence of fraud. The method is inclusive of transactions conducted by personal communication and by electronic communication; wherein electronic communication includes telephonic, computerized, digitized, optical, radio, fax, televised, wire, laser, and telepathy. In the context of this document the phrase credit cards have a generic meaning that encompasses all of the variations and derivations of the same, including check cards, ATM cards, bank cards, credit cards, gift certificate cards, and accounts administered over the Internet.

It is an object of the present invention that the method pertains to a credit card account that has a usage line, which is administered by the credit card holder, where the usage line has a paradigm that defines the criteria under which the credit line can be accessed. It most instances, the transaction refers to a pending approval of a purchase. A variation of the usage is a pending cash advance request.

A second object of the invention is that the method has enhanced security without unduly adding to the cost or to the speed of a transaction. To this end, transaction decisions will not necessarily require hubs with a multiplicity of computers requiring essentially simultaneous communication, but will have greater input from the cardholder, where the cardholder has a vested interest in reducing fraud.

A third object of the invention is that the trend toward ever increasing complex encryption and cross-checking against obscure artificial numbers and passwords will be offset by the inclusion of the usage line. The usage line is idiosyncratically human in its focus, dealing with traditionally human issues like buying patterns, travel plans, preferred merchants, timeframes and geographic considerations. Constraints on the size and frequency of transactions can be incorporated into the usage line. Because the usage line is more involved with human concerns it will therein be friendlier to use without loss of complexity. The usage line can also set a trigger number for the rejections of the card, and if the card is rejected how does the cardholder want to be contacted, and whether the account is to be suspended. Credit cards used by businesses or government entities would tailor their criteria to reflect their needs. Restrictions on purchases that have no connection to legitimate business concerns could be blocked.

A fourth object of the invention is that within the method there can be merchant incentives and cardholder incentives built into the authorized user account that would encourage purchasing from a specified merchant. For instance grocery stores could compete for customers by offering various discounts if the user shops at their store.

A fifth object of the invention is that the method includes one or more mechanisms by which the authorized user can view his or her usage line. Currently, most of the larger banks already offer Internet access to clients credit card accounts. Banks also provide access by telephone. Additional measurers to tighten the security for accessing the usage line would not be necessary, because the usage line is used primarily only to further constrain access to the line of credit. Therefore, the security systems already in place should be adequate. It is envisaged that a cardholder that limits the possibilities for fraud, possibly could be rewarded with a lower interest rate.

A sixth object of the invention is that the method includes a tracking means by which the authorized user can see not only view transactions that were approved, but also transactions that were declined. Preferably the tracking means will report the identity of the merchant, a generic description of the merchandise, a date, an amount, and an explanation as to why the transaction was approved or declined. The explanation can be in the form of a code, like the banking term NSF, has come to be synonymous with Insufficient Funds. The tracking means will be of great assistance to the cardholder in analyzing foiled fraudulent attempts on the account. Additionally, in the shake out phases of a new cardholder, it is important that both the merchant and especially the cardholder have a good understanding of why a transaction was declined. The merchant has used his resources to run the charge, and the cardholder is embarrassed by the declination. The offering fiduciary institution and the card processor also need to have confidence that they are processing the charges properly. Preferably the tracking means will have a testing means to confirm whether a hypothetical purchase will be approved or declined, as determined by the usage line. The preferred testing means is an interactive algorithm that the authorized user can activate, where the algorithm generates a series of hypothetical transactions based on the paradigm set up in the usage line, the results of the transactions alerting the authorized user of potentially unwanted constraints.

A seventh object of the method is, that at the user's discretion, a pending merchant approval for payment request must, additionally, receive the explicit approval or authorization by the user; and where the authorization is conducted in real time, at the time of the request. This object creates an automatic feedback to the user that a transaction is pending until the user issues authorization.

In general banks are concerned with two questions. Is the presenter of the credit card the authorized user, and does the user have sufficient wealth to approve advancing him the requested finds. In short can the bank get its money back, so that it can be lent again. These questions are not particularly aimed at preventing fraud. The cardholder has a more direct, vested interest in preventing fraud as he will be charged initially, and maybe ultimately, for the misappropriated funds, and as such it is his best interest to prevent fraud at the merchant level rather than in a criminal proceeding after the fact. He can do this by using his foreknowledge of his buying plans to narrow approve merchants, applying windows of time when a transaction can be approved, and also specifying the amount. In a general sense, he can also limit his exposure by limiting the number and amount of the transaction. The banker could implement some of these restrictions, but as a practical matter, to be of a sufficient deterrent to fraud, only the authorized user has the detailed knowledge of his requirements to be able to narrow the window such that it will have an impact. Therefore the cardholder must be administrator.

To be an effective administrator the authorized user must have ready access to the usage line. Internet access would certainly be the simplest way to accomplish this on a wide scale, however similar results could be achieved using an ATM, using a wireless communication device, a line transmission device such a telephone or a facsimile, by postal mail, or in person. The later two methods would not be totally automated, and therefore less preferable from the perspective of increased cost to administer.

The invention is a credit card account with an authorized user and an issuing bank, where said credit card account has a line of credit and a usage line, where the usage line is a paradigm developed and administered by the authorized user, where the paradigm is a set of criteria for granting permission to access the line of credit, such that at the discretion of the authorized user, a pending request for payment could require approval from both the authorized user and the issuing bank.

The invention works as described in a method consisting of the following steps.

1. An authorized user accesses his credit card account which has a usage line, where the usage line, which is solely administrated by the authorized user, is a paradigm that optionally defines approved merchants, approved times, coincident user approval, and other criteria as established by the user.

2. The user presents or communicates his credit card, at time of a purchase, to the merchant.

3. The merchant contacts a card processor, initiating a request that funds be transferred from the account to the merchant.

4. The card processor relays the request to an issuing bank for the credit card account.

5. The issuing bank individually processes the request through the account and through the usage line, said processing generating a first result for the account, and a second result for the usage line, where a usage line requirement can be the explicit, real time coincident user approval.

6. The issuing bank compares the results and issues a reply to the card processor that the request is approved if both the first result and the second result are approved, or replies that the requests is declined if either result is not approved.

7. The card processor communicates the reply to the merchant.

8. The merchant completes the purchase, or notifies user that card was declined.

In a variation on the method, the card processor could serve as the hub for comparing the first result and the second result. That is the usage line need not be located within the bank, or even controlled by the bank. The usage line could be housed virtually anywhere there is an Internet server having a database that contained the cardholder's usage line. Examples of appropriate locations are the card processor, the merchant, or a contract database provider having instant access. The usage line could even be housed by the buyer himself, as in the case of large corporations or government entities. In this scenario the card processor would send the merchant's request to the issuing bank and to the buyer.

Note, that the usage line and the card account do not have to be processed serially. This allows analysis of the merchant's request to speed up, because if the either decision is no then the request will be denied. The use of parallel processing will frequently shorten the time required to complete the transaction.

From the perspective of the authorized user, the process of creating and administering the usage line. Where the usage line is associated with a bank issuing the credit card would proceed by the following steps.

a.) Establishing a credit card account with an offering fiduciary institution, where the account has a usage line and a line of credit, and wherein, ultimately, the account can be accessed and viewed on a computerized screen;

b.) Setting communication protocols and security profiles for accessing the credit card account for remote viewing of the account, where said account has an activity register;

c.) Opening the usage line and start building the paradigm that, optionally, defines criteria for approving a credit card purchase; that, optionally, defines criteria for automatic contact of the authorized user for explicit real time approval, defines circumstances for the suspension of activity of the card, defines criteria for a cash advance, and that turns on a tracking means;

d.) Activating the card;

e.) Running, optionally, an algorithm that is a testing means, and, initiate, optionally, at least one test purchase, preferably one that should be approved and one that should be declined by the usage line;

f) Opening the activity register and the tracking means section of the usage line, confirming that the desired transactions occurred;

g.) Reviewing, periodically, the activity register to confirm that there has been no suspicious activity; and

h.) Amending the usage line to reflect anticipated changes in spending habits, such as a single large purchase having a narrow window of time, or a purchase over the Internet with a new merchant.

The method for upgrading a conventional pre-existing credit card account, to an account with a usage line would proceed through essentially the same set of steps, except that the authorized user may have already viewed the activity register on line, so there would be no need to establish protocols and passwords, as these would already be in place.

BRIEF DESCRIPTION OF THE DRAWINGS

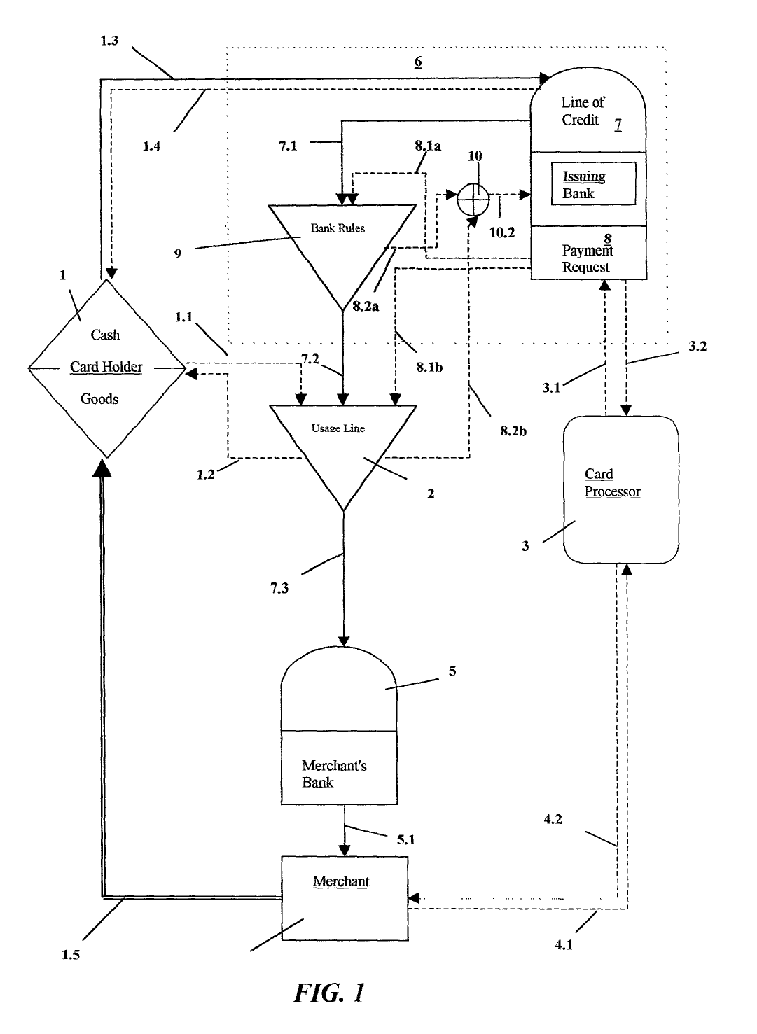

FIG. 1 is schematic drawing of the invention, showing how the method functions with the various entities involved in a credit card transaction. Dashed lines indicate communication, solid lines indicate the movement of money, and double solid lines indicate the movement of goods and services.

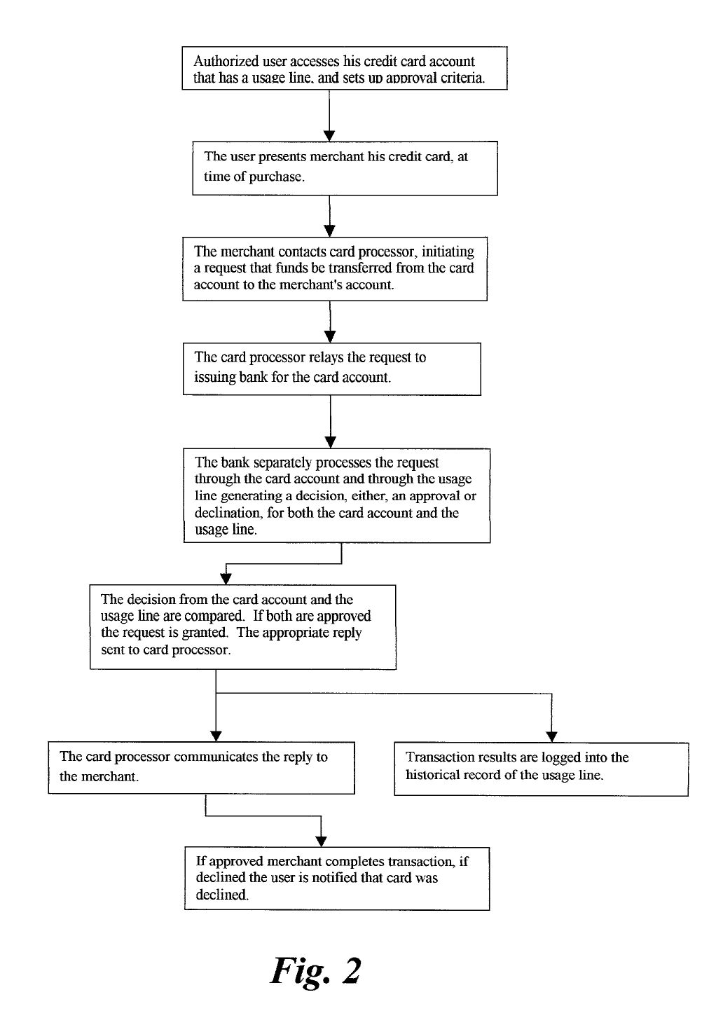

FIG. 2 is a flowchart of the steps in the method, in accordance with the description of the preferred embodiment. As indicated above there are equivalents that that might better suit a particular situation.

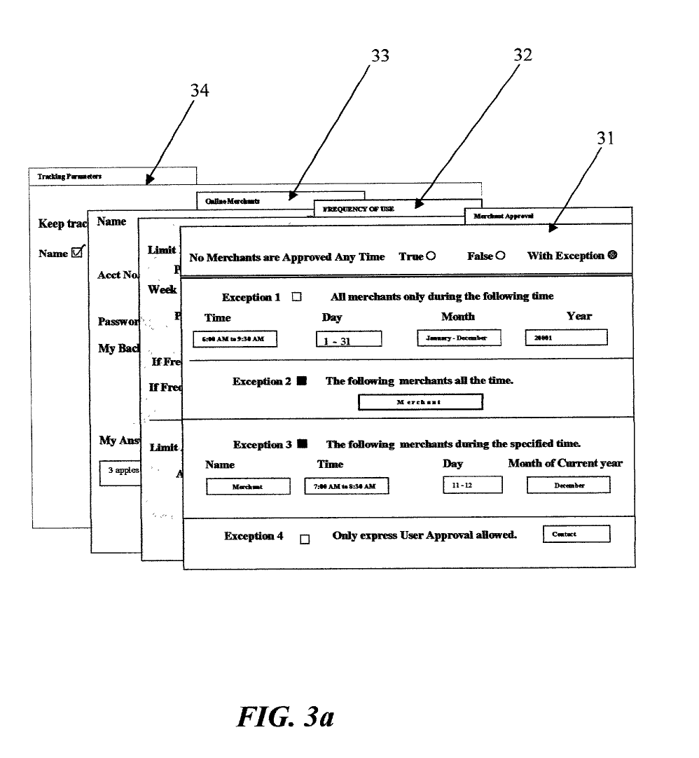

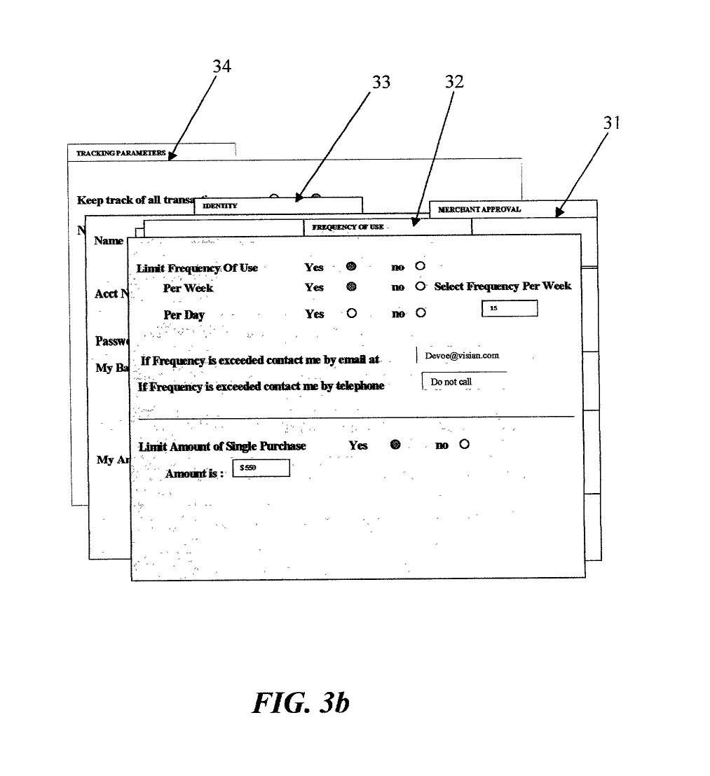

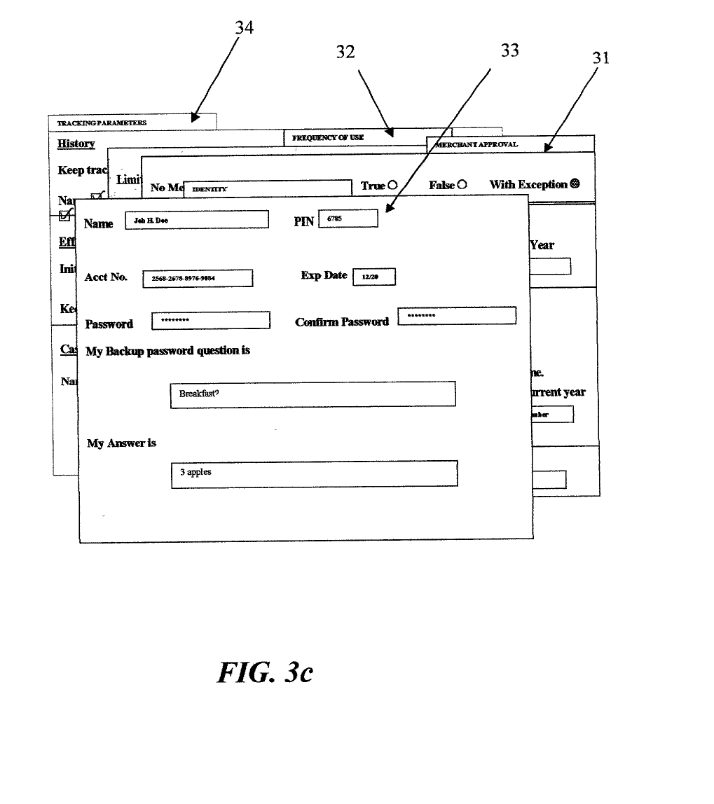

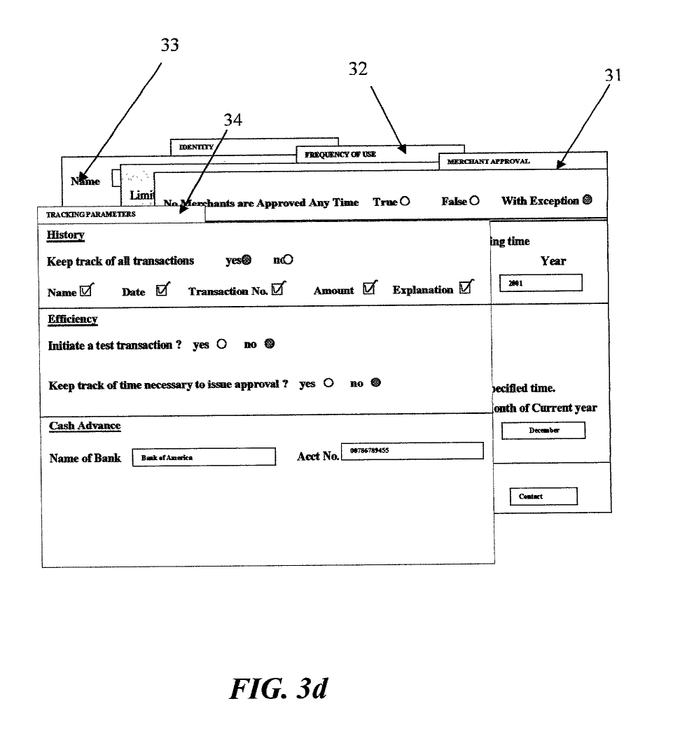

FIGS. 3a-3d are cascaded views of a screen showing various criteria that could be selected by the authorized user.

### DETAILED DESCRIPTION OF THE PREFERRED ILLUSTRATED EMBODIMENT

The invention is shown in the context of a common utilization of a credit card purchase. The Cardholder 1 has established an account with a bank 6 that issued the card. The cardholder is notified by the bank of the balance of his card account. Notification is usually communicated by mail. This communication is shown as dashed line 1.4. In turn, the cardholder is expected to send a payment. The movement of money is shown by solid line 1.3. When the cardholder buys goods and services they are transferred from a merchant 4 to the cardholder. The movement of goods and services is shown by a double solid line 1.5. The merchant has an account in bank 5, and when he receives payment monies are deposited into his account, as shown by solid line 7.3, and then to the merchant as he spends the money, shown by solid line 5.1. In a typical credit card purchase when the cardholder presents his card, the cardholder is representing that he is the owner of the card account, and as such can legally charge against that account. It is to the merchant's advantage to accept the cardholder at face value. In most cases, the merchant will not have personal knowledge of the cardholder, and infrequently even asks for an additional form of identification, or to check the signature on the back. With a telephone or Internet purchase these forms of confirming identification are not available. At the point of purchase the merchant 4 sends to the card processor 3 the information necessary to complete the transaction. The information needed is the merchant's identity, the cardholder's name, the type of card, the card number, the expiration date and the purchase price. In the case of a debit card a PIN number is also necessary. The merchant contacts the card processor 3, relaying the pertinent information as shown by dashed line 4.1; requesting that funds be transfer from the cardholder's account to his bank account. The card processor 3 checks his database for the name of the appropriate bank, and then sends the requests, dashed line 3.1, to bank credit card center 8. The credit card center inquires of the bank rules 9, shown as dashed line 8.1a if the cardholder has made his monthly payment and has sufficient line of credit 7 to cover the purchase price. The determination is communicated, shown as dashed line 8.2a from the card center 8 back to the merchant, as shown by dashed lines 3.1 and 4.2. If approved the merchant completes the transaction, and funds are moved from the bank 6 to merchant's bank 5, as shown by dashed lines 7.1, 7.2 and 7.3.

In the invention the method of making a card purchase has been modified, but not so that it is perceptible to the merchant. The method greatly isolates the cardholder against use by an unauthorized user. The cardholder 1 creates a paradigm that reflects the cardholders approved merchants, time window for a purchase, and a limit of the size of the purchase, or he can elect to not change any of the rules governing access to his line of credit. The cardholder can also stipulate in the paradigm, that no request be approve unless explicitly approved by the user. The paradigm defines the criteria under which the user is to be contacted for approval. Typical conventions include email, instant messenger, automated telephonic communication such as telephone, cellular phone and pager. Alternatively, the user could be contacted at a web page, cable TV or radio or via wireless communication. The cardholder has the discretion of tracking all purchases and attempted purchases. The cardholder, after initially establishing security measures that typically already in place for administering checking accounts and credit card accounts, goes online and sets up a usage account 2. The online communication is shown by dashed line 1.1. The usage account lets him set the criteria under which his line of credit can be accessed. In the instant invention the usage line is shown to be an adjunct to his card account, but not under the banks direct jurisdiction. The usage line can be set so that under certain conditions, for instance an unsuccessful attempt to access the line of credit, he will automatically be notified. This is shown by dashed line 1.2.

In the scenario just described once the bank gets the request for payment, not only does the bank card center 8 send the request to the bank rules 9 for a determination on the available credit, it also sends the request on a parallel path, dashed line 8.1b, to the usage line 2. Processing results are passed along dashed line 8.2b, to a decision approval hub 10. If the requests is turned down by either the bank rules 9 or the usage line 2, the hub 10 can issue a non approval to the request, without having to wait on the other processing leg. The result of the comparison is communicated to the card center, as shown with dashed line 10.2, and back to the merchant.

FIG. 2 is a flowchart giving the steps in the method. The method in FIG. 2 has an additional step than the method disclosed in the Summary Of The Invention. In the detailed embodiment the authorized user has elected to keep track of all requests for payment, so that those that are declined are in the record, as well those transactions that are successful.

Our attention is now turned to how the cardholder has set up the usage line. In the instant invention this was effected over the Internet at a secure web site created for the authorized user. FIGS. 3a-3d show how the web site might look. When the authorized user logs on for the first time he will be directed to a folder that contains the identity information. The folder is shown in FIG. 3c, number 33. In this folder the authorized user would enter changes in his password, a password prompting question and answer, a PIN number, and other information deemed important to connect the user to the identified numbered account. After updating the identity folder the authorized user would switch over to the merchant approval folder, show in FIG. 3a, number 31. In the first option, the cardholder can choose to suspend any declaration of approved merchants by clicking on the radio button labeled “False” in response to the statement “No Merchants are Approved Any Time”. This election takes away many of the fraud prevention features, however it might be the desired selection if the cardholder is getting ready to go on a trip. Under most circumstances the cardholder would choose one or more of the four listed exceptions. Exception 4 is most narrow, and it would probably be the criteria of choice if the cardholder is going to make a purchase from a merchant of unknown reputation, and the user wanted to limit the transaction to only those requiring user approval. The combo labeled contact is a list of options that define how the user wants to be contacted. For internet purchases email, would be a obvious selection. When the merchant enters his request for payment, then request would be routed to the usage line, where the request would be forwarded to the user 1.2, who in turn would issue an approval. The approval would go back to the usage line along route 1.1, where the approval is passed along to the decision hub 10. Exception 3 is the next most restrictive condition. Selecting exception 3 rule you can narrow the window of time when a request will be approved to just a matter of minutes. In the example shown the time is 7:00AM to 8:30 AM on both December 11^{th} and 12^{th} of the current year. The user in this example also checked Exception 2. The combo box entitled “Merchant”, contains a list of approved merchants that the authorized user has selected. Exception 1 is the another set of preferences that the user can select. It has the effect of setting up a selected window of time when the card account can be accessed. If an unauthorized user attempts to use the card, he might well be successful the first time however, it is unlikely he would know the approved window of time. The folder titled “Frequency Of Use” number 32, as shown in FIG. 3b, would likely foil the thief rather quickly. In this folder the authorized user defines criteria that will limit the cardholders liability, by limiting the number of times that the card can be used and the maximum cost of any purchase. If an attempt is made to use the card more than allowed the authorized user, John H. Doe”, has requested that he be contacted at the email address of devoe@visian.com. The address could be the user, the police, or other authorities named by the cardholder. In the folder entitled “Tracking Parameters” number 34, in FIG. 3d, the user can select to keep a log of all transactions, and what information to keep. John Doe has wisely selected to keep a record. Not shown on this particular folder is where the record would be recorded. An obvious place is on the activity register of the credit card. In the second section of the Tracking Parameter folder is the question “Initiate a test transaction?” When selecting criteria for the usage line, you want to know that the actual purchase will process like you believe that you have criteria set. This feature allows the user to confirm that idea the criteria are set up correctly. The default position of the radio button will be “no”. Another tracking feature is keep track of the time. If you fine that processing time is slowing you may want to confirm this information. In the third section of the tracking parameters are the criteria that establish to whose account money will be transferred in the case of a cash advance.

It is anticipated that the selectable parameters in the usage box will evolve as consumer demand changes. Businesses would adopt a different set of criteria to meet their needs. Also it is anticipated that supervision and physical location the usage line, need not fall under the umbrella of a bank. In recognition of this the usage line 2 is drawn just outside of the perimeter of the bank in FIG. 1. Inviolate, is the sole right of the authorized user, or his assigns, to administer the usage line.

We claim:

1. A method for reducing credit card fraud consisting of the following steps:
1. An authorized user accesses his credit card account which has a usage line, where the usage line, which is solely administrated by the authorized user, is a paradigm that optionally defines approved merchants, approved times, coincident user approval and other criteria as established by the user.
2. The user presents or communicates his credit card, at time of a purchase, to the merchant.
3. The merchant contacts a card processor, initiating a request that funds be transferred from the account to the merchant.
4. The card processor relays the request to an issuing bank for the credit card account.
5. The issuing bank individually processes the request through the account and through the usage line, said processing generating a first result for the account, and a second result for the usage line.
6. The issuing bank compares the results and issues a reply to the card processor that the request is approved if both the first result and the second result are approved, or replies that the requests is declined if either result is not approved.
7. The card processor communicates the reply to the merchant.
8. The merchant completes the purchase, or notifies user that card was declined.

2. A process for administering the method described in claim 1, where the process consists of the following steps:
a.) Establishing a credit card account with an offering fiduciary institution, where the account has a usage line and a line of credit, and wherein, ultimately, the account can be accessed and viewed on a computerized screen;
b.) Setting communication protocols and security profiles for accessing the credit card account for remote viewing of the account, where said account has an activity register;
c.) Opening the usage line and start building the paradigm that, optionally, defines criteria for approving a credit card purchase; that, optionally, defines criteria for automatic contact of the authorized user and circumstances for the suspension of activity of the card, that, optionally, defines criteria for a cash advance; that turns on a tracking means;
d.) Activating the card;
e.) Running, optionally, an algorithm that is a testing means, and, initiate, optionally, at least one test purchase, preferably one that should be approved and one that should be declined by the usage line;
f.) Opening the activity register and the tracking means section of the usage line, confirming that the desired transactions occurred;
g.) Reviewing, periodically, the activity register to confirm that there has been no suspicious activity; and
h.) Amending the usage line to reflect anticipated changes in spending habits, such as a single large purchase having a narrow window of time, or a purchase over the Internet with a new merchant.

3. A credit card account with an authorized user and an issuing bank, where said credit card account has a line of credit and a usage line, where the usage line is a paradigm developed and administered by the authorized user, where the paradigm is a set of criteria for granting permission to access the line of credit, such that at the discretion of the authorized user, a pending request for payment could require approval from both the authorized user and the issuing bank.

4. A credit card account as claimed in claim 3, where the paradigm of the usage line allows the authorized user to optionally define approved merchants, approved transaction times and dates, approved maximum transaction amounts and whether the user requests explicit, real time, approval.

5. A credit card account as claimed in claim 4 where the usage line requests explicit, real time approval, wherein a preferred means of approval is via email.

6. A credit card account as claimed in claim 3, where said usage line is accessible to the authorized user through a web site.

7. A credit card account as claimed in claim 3 where the paradigm of said usage line allows the authorized user to optionally elect to keep a record a transaction, where the record reflects both approved and declined requests for payment.

8. A credit card account as claimed in claim 8 where said record acts a ready source for the authorized user to evaluate whether any unauthorized transactions were attempted.

9. A credit card account as claimed in claim 7, where said usage line is accessible to the authorized user through a web site.

10. A credit card account as claimed in claim 7, where the paradigm of the usage line allows the authorized user to optionally define approved merchants, approved transaction times and dates, approved maximum transaction amounts and whether the user requests explicit, real time, approval.

11. A credit card account as claimed in claim 8 where the usage line requests explicit, real time approval, wherein a preferred means of approval is via email.

12. A credit card account as claimed in claim 3, where the usage line is defined so that the authorized user grants approval for use to his business representatives, and the usage line is defined so that only legitimate business purchases can be made.
